(19) United States
(12) Patent Application Publication
(10) Pub. No.: US 2008/0019669 A1
(43) Pub. Date: Jan. 24, 2008

(54) Automatically editing video data

(76) Inventors: Sahra Reza Girshick, Palo Alto, CA (US); Pere Obrador, Palo Alto, CA (US); Tong Zhang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/488,316

(22) Filed: Jul. 18, 2006

(51) Int. Cl. H04N 5/00

(52) U.S. Cl. 386/117

(57) ABSTRACT

Systems and methods of automatically editing video data containing a sequence of video frames are described. Respective frame characterizing parameter values and respective camera motion parameter values are determined for each of the video frames. A respective frame score is computed for each of the video frames based on the determined frame characterizing parameter values. Segments of consecutive ones of the video frames are identified based at least in part on a thresholding of the frame scores. Shots of consecutive ones of the video frames having motion parameter values meeting a motion quality predicate are selected from the identified segments. An output video is generated from the selected shots.

### BACKGROUND

The recent availability of low-cost digital video cameras has allowed amateur videographers to capture large quantities of raw (i.e., unedited) video data. Raw video data, however, typically is characterized by a variety of problems that make such content difficult to watch. For example, most raw video data is too long overall, consists of individual shots that capture short periods of interesting events interspersed among long periods of uninteresting subject matter, and has many periods with undesirable motion qualities, such as jerkiness and rapid pan and zoom effects.

In order to remove these problems, the raw video data must be edited. Most manual video editing systems, however, require a substantial investment of money, time, and effort before they can be used to edit raw video content. Even after a user has become proficient at using a manual video editing system, the process of editing raw video data typically is time-consuming and labor-intensive. Although some approaches for automatically editing video content have been proposed, these approaches typically cannot produce high-quality edited video from raw video data. As a result, most of the video content that is captured by amateur videographers remains stored on tapes and computer hard drives in an unedited and difficult to watch raw form.

What are needed are methods and systems that are capable of automatically producing high quality edited video from raw video data.

### SUMMARY

The invention features methods and systems of processing input video data containing a sequence of video frames. In accordance with these inventive methods and systems, respective frame characterizing parameter values and respective camera motion parameter values are determined for each of the video frames. A respective frame score is computed for each of the video frames based on the determined frame characterizing parameter values. Segments of consecutive ones of the video frames are identified based at least in part on a thresholding of the frame scores. Shots of consecutive ones of the video frames having motion parameter values meeting a motion quality predicate are selected from the identified segments. An output video is generated from the selected shots.

Other features and advantages of the invention will become apparent from the following description, including the drawings and the claims.

### DESCRIPTION OF DRAWINGS

FIG. 1 is a block diagram of an embodiment of a video data processing system.

FIG. 2 is a flow diagram of an embodiment of a video data processing method.

FIG. 3 is a block diagram of an embodiment of a frame characterization module.

FIG. 4 is a flow diagram of an embodiment of a method of determining image quality scores for a video frame.

FIG. 5A shows an exemplary video frame.

FIG. 5B shows an exemplary segmentation of the video frame of FIG. 5A into sections.

FIG. 6 is a flow diagram of an embodiment of a method of determining camera motion parameter values for a video frame.

FIG. 7A shows a frame score threshold superimposed on an exemplary graph of frame scores plotted as a function of frame number.

FIG. 7B is a graph of the frame scores in the graph shown in FIG. 7A that exceed the frame score threshold plotted as a function of frame number.

FIG. 8 is a devised set of segments of consecutive video frames identified based at least in part on the thresholding of the frame scores shown in FIGS. 7A and 7B.

FIG. 9 is a devised graph of motion quality scores indicating whether or not the motion quality parameters of the corresponding video frame meet a motion quality predicate.

FIG. 10 is a devised graph of shots of consecutive video frames selected from the identified segments shown in FIG. 8 and meeting the motion quality predicate as shown in FIG. 9.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. INTRODUCTION

### A. Exemplary Embodiment of a Video Data Processing System

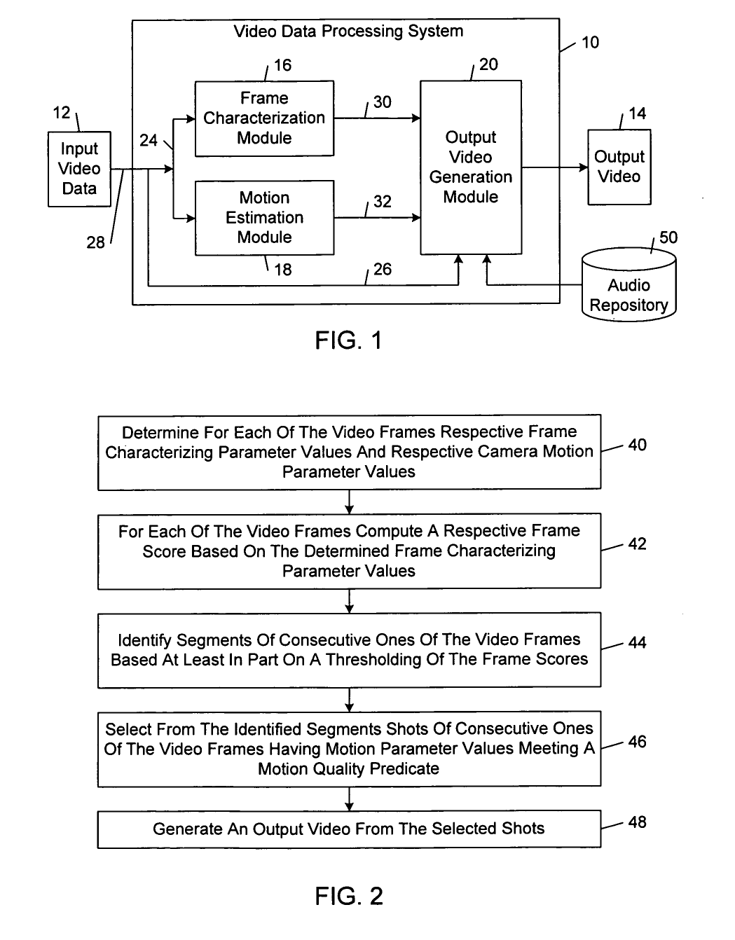

FIG. 1 shows an embodiment of a video data processing system 10 that is capable of automatically producing high quality edited video content from input video data 12. As explained in detail below, the video data processing system 10 processes the input video data 12 in accordance with filmmaking principles to automatically produce an output video 14 that contains a high quality video summary of the input video data 12. The video data processing system 10 includes a frame characterization module 16, a motion estimation module 18, and an output video generation module 20.

In general, the input video data 12 includes video frames 24 and audio data 26. The video data processing system 10 may receive the video frames 24 and the audio data 26 as separate data signals or a single multiplex video data signal 28, as shown in FIG. 1. When the input video data 12 is received as a single multiplex signal 28, the video data processing system 10 separates the video frames 24 and the audio data 26 from the single multiplex video data signal 28 using, for example, a demultiplexer (not shown), which passes the video frames 24 to the frame characterization module 16 and the motion estimation module 18 and passes the audio data 26 to the output video generation module 20. When the video frames 24 and the audio data 26 are received as separate signals, the video data processing system 10 passes the video frames 24 directly to the frame characterization module 16 and the motion estimation module 18 and passes the audio data 26 directly to the output video generation module 20.

As explained in detail below, the frame characterization module 16 produces one or more respective frame characterizing parameter values 30 for each of the video frames 24 in the input video data 12. The motion estimation module 18 produces one or more camera motion parameter values 32 for each of the video frames 24 in the input video data 12. The output video generation module 20 selects a set of shots of consecutive ones of the video frames 24 based on the frame characterizing parameter values 30 and the camera motion parameter values 32. The output video generation module 20 generates the output video 14 from the selected shots and optionally the audio data 26 or other audio content.

The video data processing system 10 may be used in a wide variety of applications, including video recording devices (e.g., VCRs and DVRs), video editing devices, and media asset organization and retrieval systems. In general, the video data processing system 10 (including the frame characterization module 16, the motion estimation module 18, and the output video generation module 20) is not limited to any particular hardware or software configuration, but rather it may be implemented in any computing or processing environment, including in digital electronic circuitry or in computer hardware, firmware, device driver, or software. For example, in some implementations, the video data processing system 10 may be embedded in the hardware of any one of a wide variety of electronic devices, including desktop and workstation computers, video recording devices (e.g., VCRs and DVRs), and digital camera devices. In some implementations, computer process instructions for implementing the video data processing system 10 and the data it generates are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable hard disks, magneto-optical disks, and CD-ROM.

### B. Exemplary Embodiment of a Video Data Processing Method

FIG. 2 shows an embodiment of a method by which the video data processing system 10 generates the output video 14.

In accordance with this method, the frame characterization module 16 determines for each of the video frames 24 respective frame characterizing parameter values 30 and the motion estimation module 18 determines for each of the video frames 24 respective camera motion parameter values 32 (FIG. 2, block 40). The frame characterization module 16 derives the frame characterizing parameter values from the video frames 24. Exemplary types of frame characterizing parameters include parameter values relating to sharpness, contrast, saturation, and exposure. In some embodiments, the frame characterization module 16 also derives from the video frames 24 one or more 10 facial parameter values, such as the number, location, and size of facial regions that are detected in each of the video frames 24. The motion estimation module 18 derives the camera motion parameter values from the video frames 24. Exemplary types of motion parameter values include zoom rate and pan rate.

The output video generation module 20 computes for each of the video frames 24 a respective frame score based on the determined frame characterizing parameter values 30 (FIG. 2, block 42). The frame score typically is a weighted quality metric that assigns to each of the video frames 24 a quality number as a function of an image analysis heuristic. In general, the weighted quality metric may be any value, parameter, feature, or characteristic that is a measure of the quality of the image content of a video frame. In some implementations, the weighted quality metric attempts to measure the intrinsic quality of one or more visual features of the image content of the video frames 24 (e.g., color, brightness, contrast, focus, exposure, and number of faces or other objects in each video frame). In other implementations, the weighted quality metric attempts to measure the meaningfulness or significance of an image to the user. The weighted quality metric provides a scale by which to distinguish “better” video frames (e.g., video frames that have a higher visual quality are likely to contain image content having the most meaning, significance and interest to the user) from the other video frames.

The output video generation module 20 identifies segments of consecutive ones of the video frames 24 based at least in part on a thresholding of the frame scores (FIG. 2, block 44). The thresholding of the frame scores segments the video frames 24 into an accepted class of video frames that are candidates for inclusion into the output video 14 and a rejected class of video frames that are not candidates for inclusion into the output video 14. In some implementations, the output video generation module 20 may reclassify ones of the video frames from the accepted class into the rejected class and vice versus depending on factors other than the assigned frame scores, such as continuity or consistency considerations, shot length requirements, and other filmmaking principles.

The output video generation module 20 selects from the identified segments shots of consecutive ones of the video frames 24 having motion parameter values meeting a motion quality predicate (FIG. 2, block 46). The output video generation module 20 typically selects the shots from the identified segments based on user-specified preferences and filmmaking rules. For example, the output video generation module 20 may determine the in-points and out-points for ones of the identified segments based rules specifying one or more of the following: a maximum length of the output video 14; maximum shot lengths as a function of shot type; and in-points and out-point locations in relation to detected faces and object motion.

The output video generation module 20 generates the output video 14 from the selected shots (FIG. 2, block 48). The selected shots typically are arranged in chronological order with one or more transitions (e.g., fade out, fade in, dissolves) that connect adjacent ones of the selected shots in the output video 14. The output video generation module 20 may incorporate an audio track into the output video 14. The audio track may contain selections from one or more audio sources, including the audio data 26 and music and other audio content selected from an audio repository 50 (see FIG. 1).

### II. EXEMPLARY COMPONENTS OF THE VIDEO DATA PROCESSING SYSTEM

### A. Exemplary Embodiments of the Frame Characterization Module

1. Overview

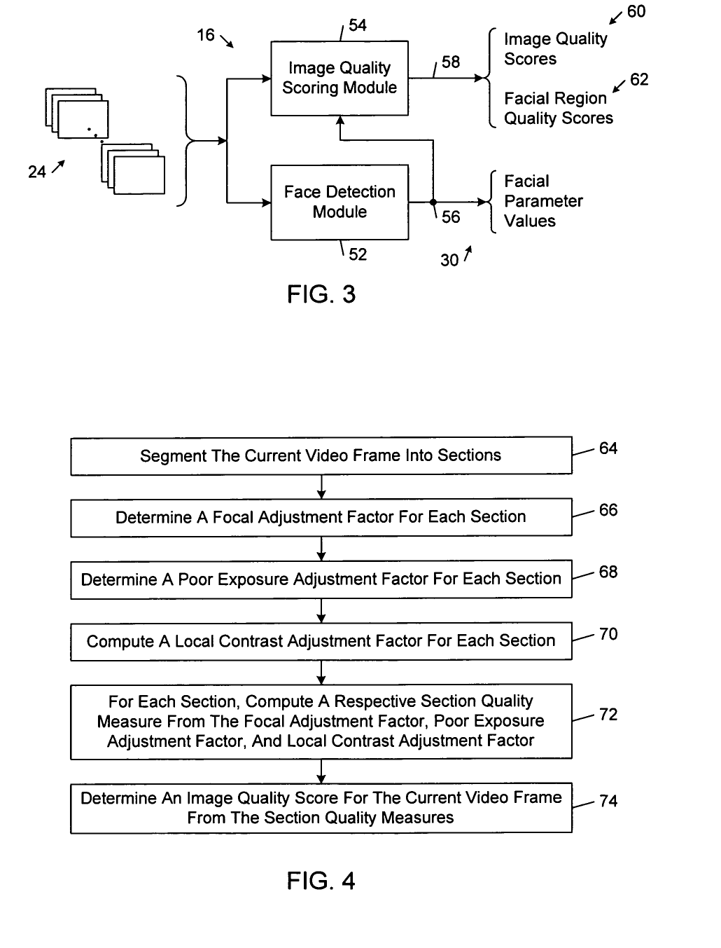

FIG. 3 shows an embodiment of the frame characterization module 16 that includes a face detection module 52 and an image quality scoring module 54.

The face detection module 52 detects faces in each of the video frames 24 and outputs one or more facial parameter values 56. Exemplary types of facial parameter values 56 include the number of faces, the locations of facial bounding boxes encompassing some or all portions of the detected faces, and the sizes of the facial bounding boxes. In some implementations, the facial bounding box corresponds to a rectangle that includes the eyes, nose, mouth but not the entire forehead or chin or top of head of a detected face. The face detection module 52 passes the facial parameter values 56 to the image quality scoring module 54 and the output video generation module 20.

The image quality scoring module 54 generates one or more image quality scores 58 for each of the video frames 24. In the illustrated embodiments, the image quality scoring module 54 generates respective frame quality scores 60 and facial region quality scores 62. Each of the image quality scores 60 is indicative of the overall quality of a respective one of the video frames 24. Each of the facial region quality scores 62 is indicative of the quality of a respective one of the facial bounding boxes. The image quality scoring module 54 passes the image quality scores 58 to the output video generation module 20.

2. Detecting Faces in Video Frames

In general, the face detection module 52 may detect faces in each of the video frames 24 and compute the one or more facial parameter values 56 in accordance with any of a wide variety of face detection methods.

For example, in some embodiments, the face detection module 52 is implemented in accordance with the object detection approach that is described in U.S. Patent Application Publication No. 2002/0102024. In these embodiments, the face detection module 52 includes an image integrator and an object detector. The image integrator receives each of the video frames 24 and calculates a respective integral image representation of the video frame. The object detector includes a classifier, which implements a classification function, and an image scanner. The image scanner scans each of the video frames in same sized subwindows. The object detector uses a cascade of homogenous classifiers to classify the subwindows as to whether each subwindow is likely to contain an instance of a human face. Each classifier evaluates one or more predetermined features of a human face to determine the presence of such features in a subwindow that would indicate the likelihood of an instance of the human face in the subwindow.

In other embodiments, the face detection module 52 is implemented in accordance with the face detection approach that is described in U.S. Pat. No. 5,642,431. In these embodiments, the face detection module 52 includes a pattern prototype synthesizer and an image classifier. The pattern prototype synthesizer synthesizes face and non-face pattern prototypes are synthesized by a network training process using a number of example images. The image classifier detects images in the video frames 24 based on a computed distance between regions of the video frames 24 to each of the face and non-face prototypes.

In response to the detection of a human face in one of the video frames, the frame detection module 52 determines a facial bounding box encompassing the eyes, nose, mouth but not the entire forehead or chin or top of head of the detected face. The face detection module 52 outputs the following metadata for each of the video frames 24: the number of faces, the locations (e.g., the coordinates of the upper left and lower right corners) of the facial bounding boxes, and the sizes of the facial bounding boxes.

3. Determining Image Quality Scores

FIG. 4 shows an embodiment of a method of determining a respective image quality score for each of the video frames 24. In the illustrated embodiment, the image quality scoring module 54 processes the video frames 24 sequentially.

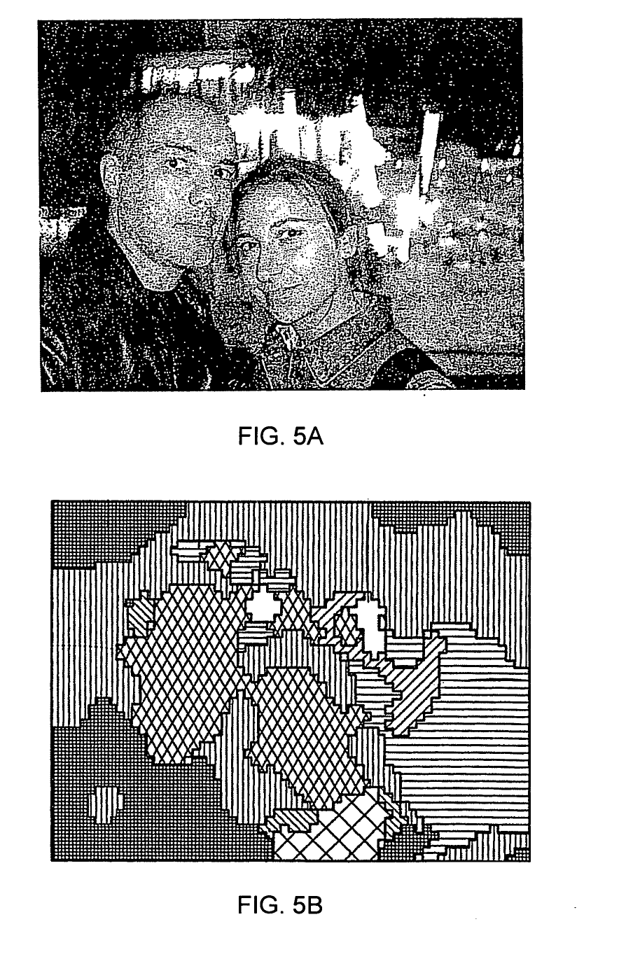

In accordance with this method, the image quality scoring module 54 segments the current video frame into sections (FIG. 4, block 64). In general, the image quality scoring module 54 may segment each of the video frames 24 in accordance with any of a wide variety of different methods for decomposing an image into different objects and regions. FIG. 5B shows an exemplary segmentation of the video frame of FIG. 5A into sections.

The image quality scoring module 54 determines focal adjustment factors for each section (FIG. 4, block 66). In general, the image quality scoring module 54 may determine the focal adjustment factors in a variety of different ways. In one exemplary embodiment, the focal adjustment factors are derived from estimates of local sharpness that correspond to an average ratio between the high-pass and low-pass energy of the one-dimensional intensity gradient in local regions (or blocks) of the video frames 24. In accordance with this embodiment, each video frame 24 is divided into blocks of, for example, 100×100 pixels. The intensity gradient is computed for each horizontal pixel line and vertical pixel column within each block. For each horizontal and vertical pixel direction in which the gradient exceeds a gradient threshold, the image quality scoring module 54 computes a respective measure of local sharpness from the ratio of the high-pass energy and the low-pass energy of the gradient. A sharpness value is computed for each block by averaging the sharpness values of all the lines and columns within the block. The blocks with values in a specified percentile (e.g., the thirtieth percentile) of the distribution of the sharpness values are assigned to an out-of-focus map, and the remaining blocks (e.g., the upper seventieth percentile) are assigned to an in-focus map.

In some embodiments, a respective out-of-focus map and a respective in-focus map are determined for each video frame at a high (e.g., the original) resolution and at a low (i.e., downsampled) resolution. The sharpness values in the high-resolution and low-resolution out-of-focus and in-focus maps are scaled by respective scaling functions. The corresponding scaled values in the high-resolution and low-resolution out-of-focus maps are multiplied together to produce composite out-of-focus sharpness measures, which are accumulated for each section of the video frame. Similarly, the corresponding scaled values in the high-resolution and low-resolution in-focus maps are multiplied together to produce composite in-focus sharpness measures, which are accumulated for each section of the video frame. In some implementations, the image quality scoring module 54 scales the accumulated composite in-focus sharpness values of the sections of each video frame that contains a detected face by multiplying the accumulated composite in-focus sharpness values by a factor greater than one. These implementations increase the quality scores of sections of the current video frame containing faces by compensating for the low in-focus measures that are typical of facial regions.

For each section, the accumulated composite out-of-focus sharpness values are subtracted from the corresponding scaled accumulated composite in-focus sharpness values. The image quality scoring module 54 squares the resulting difference and averages the product by the number of pixels in the corresponding section to produce a respective focus adjustment factor for each section. The sign of the focus adjustment factor is positive if the accumulated composite out-of-focus sharpness value exceeds the corresponding scaled accumulated composite in-focus sharpness value; otherwise the sign of the focus adjustment factor is negative.

The image quality scoring module 54 determines a poor exposure adjustment factor for each section (FIG. 4, block 68). In this process, the image quality scoring module 54 identifies over-exposed and under-exposed pixels in each video frame 24 to produce a respective over-exposure map and a respective under-exposure map. In general, the image quality scoring module 54 may determine whether a pixel is over-exposed or under-exposed in a variety of different ways. In one exemplary embodiment, the image quality scoring module 54 labels a pixel as over-exposed if (i) the luminance values of more than half the pixels within a window centered about the pixel exceed 249 or (ii) the ratio of the energy of the luminance gradient and the luminance variance exceeds 900 within the window and the mean luminance within the window exceeds 239. On the other hand, the image quality scoring module 54 labels a pixel as under-exposed if (i) the luminance values of more than half the pixels within the window are below 6 or (ii) the ratio of the energy of the luminance gradient and the luminance variance within the window is exceeds 900 and the mean luminance within the window is below 30. The image quality scoring module 54 calculates a respective over-exposure measure for each section by subtracting the average number of over-exposed pixels within the section from 1. Similarly, the image quality scoring module 54 calculates a respective under-exposure measure for each section by subtracting the average number of under-exposed pixels within the section from 1. The resulting over-exposure measure and under-exposure measure are multiplied together to produce a respective poor exposure adjustment factor for each section.

The image quality scoring module 54 computes a local contrast adjustment factor for each section (FIG. 4, block 70). In general, the image quality scoring module 54 may use any of a wide variety of different methods to compute the local contrast adjustment factors. In some embodiments, the image quality scoring module 54 computes the local contrast adjustment factors in accordance with the image contrast determination method that is described in U.S. Pat. No. 5,642,433. In some embodiments, the local contrast adjustment factor Γ_{local}_{_{—}}_{constrast} is given by equation (1):

$${Γ}_{local\_contrast} = \begin{matrix}1 & if {L}_{σ} > 100 \\ 1 + {L}_{σ} / 100 & f {L}_{σ} \leq 100\end{matrix} \qquad ( 1 )$$

where L_{σ} is the respective variance of the luminance of a given section.

For each section, the image quality scoring module 54 computes a respective quality measure from the focal adjustment factor, the poor exposure adjustment factor, and the local contrast adjustment factor (FIG. 4, block 72). In this process, the image quality scoring module 54 determines the respective quality measure by computing the product of corresponding focal adjustment factor, poor exposure adjustment factor, and local contrast adjustment factor, and scaling the resulting product to a specified dynamic range (e.g., 0 to 255). The resulting scaled value corresponds to a respective image quality measure for the corresponding section of the current video frame.

The image quality scoring module 54 then determines an image quality score for the current video frame from the quality measures of the constituent sections (FIG. 4, block 74). In this process, the image quality measures for the constituent sections are summed on a pixel-by-pixel basis. That is, the respective image quality measures of the sections are multiplied by the respective numbers of pixels in the sections, and the resulting products are added together. The resulting sum is scaled by factors for global contrast and global colorfulness and the scaled result is divided by the number of pixels in the current video frame to produce the image quality score for the current video frame. In some embodiments, the global contrast correction factor Γ_{global}_{_{—}}_{constrast} is given by equation (2):

$${Γ}_{global\_contrast} = 1 + \sqrt{\frac{{L}_{σ}}{1500}} \qquad ( 2 )$$

where L_{σ} is the variance of the luminance for the video frame in the CIE-Lab color space. In some embodiments, the global colorfulness correction factor Γ_{global}_{_{—}}_{color} is given by equation (3):

$${Γ}_{global\_color} = 0.6 + 0.5 \cdot \sqrt{\frac{{a}_{σ} + {b}_{σ}}{500}} \qquad ( 3 )$$

where a_{σ} and b_{σ} are the variances of the red-green axis (a), and a yellow-blue axis (b) for the video frame in the CIE-Lab color space.

The image quality scoring module 54 determines the facial region quality scores 62 by applying the image quality scoring process described above to the regions of the video frames corresponding to the bounding boxes that are determined by the face detection module 52.

Additional details regarding the computation of the image quality scores and the facial region quality scores can be obtained from copending U.S. patent application Ser. No. 11/127,278, which was filed May 12, 2005, by Pere Obrador et al., is entitled “Method and System for Image Quality Calculation” [Attorney Docket No. 200503391-1], and is incorporated herein by reference.

### B. Exemplary Embodiments of the Motion Estimation Module

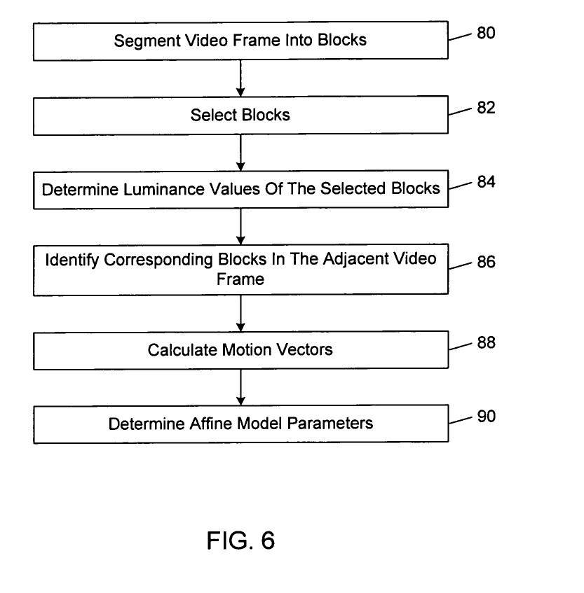

FIG. 6 shows an embodiment of a method in accordance with which the motion estimation module 18 determines the camera motion parameter values 32 for each of the video frames 24 in the input video data 12. In accordance with this method, the motion estimation module 18 segments each of the video frames 24 into blocks (FIG. 6, block 80).

The motion estimation module 18 selects one or more of the blocks of a current one of the video frames 24 for further processing (FIG. 6, block 82). In some embodiments, the motion estimation module 18 selects all of the blocks of the current video frame. In other embodiments, the motion estimation module 18 tracks one or more target objects that appear in the current video frame by selecting the blocks that correspond to the target objects. In these embodiments, the motion estimation module 18 selects the blocks that correspond to a target object by detecting the blocks that contain one or more edges of the target object.

The motion estimation module 18 determines luminance values of the selected blocks (FIG. 6, block 84). The motion estimation module 18 identifies blocks in an adjacent one of the video frames 24 that correspond to the selected blocks in the current video frame (FIG. 6, block 86).

The motion estimation module 18 calculates motion vectors between the corresponding blocks of the current and adjacent video frames (FIG. 6, block 88). In general, the motion estimation module 18 may compute the motion vectors based on any type of motion model. In one embodiment, the motion vectors are computed based on an affine motion model that describes motions that typically appear in image sequences, including translation, rotation, and zoom. The affine motion model is parameterized by six parameters as follows:

$$U = ( \begin{matrix}u \\ v\end{matrix} ) = ( \begin{matrix}{a}_{x 0} & {a}_{x 1} & {a}_{x 2} \\ {a}_{y 0} & {a}_{y 1} & {a}_{y 2}\end{matrix} ) \cdot ( \begin{matrix}x \\ y \\ z\end{matrix} ) = A \cdot ( \begin{matrix}x \\ y \\ z\end{matrix} ) \qquad ( 4 )$$

where u and v are the x-axis and y-axis components of a velocity motion vector at point (x,y,z), respectively, and the aₖ's are the affine motion parameters. Because there is no depth mapping information for a non-stereoscopic video signal, z=1. The current video frame Iᵣ(P) corresponds to the adjacent video frame Iₜ(P) in accordance with equation (5):

Iᵣ(P)=Iᵣ(P−U(P)) (5)

where P=P(x, y) represents pixel coordinates in the coordinate system of the current video frame.

The motion estimation module 18 determines the camera motion parameter values 32 from an estimated affine model of the camera's motion between the current and adjacent video frames (FIG. 6, block 90). In some embodiments, the affine model is estimated by applying a least squared error (LSE) regression to the following matrix expression:

A=(X^{T}X)⁻¹X^{T}U (6)

where X is given by:

$$X = ( \begin{matrix}{x}_{1} & {x}_{2} & … & {x}_{N} \\ {y}_{1} & {y}_{2} & … & {y}_{N} \\ 1 & 1 & … & 1\end{matrix} ) \qquad ( 7 )$$

and U is given by:

$$U = ( \begin{matrix}{u}_{1} & {u}_{2} & … & {u}_{N} \\ {v}_{1} & {v}_{2} & … & {v}_{N}\end{matrix} ) \qquad ( 8 )$$

s where N is the number of samples (i.e., the selected object blocks). Each sample includes an observation (xᵢ, yᵢ, 1) and an output (uᵢ, vᵢ) that are the coordinate values in the current and previous video frames associated by the corresponding motion vector. Singular value decomposition may be employed to evaluate equation (6) and thereby determine A. In this process, the motion estimation module 18 iteratively computes equation (6). Iteration of the affine model typically is terminated after a specified number of iterations or when the affine parameter set becomes stable to a desired extent. To avoid possible divergence, a maximum number of iterations may be set.

The motion estimation module 18 typically is configured to exclude blocks with residual errors that are greater than a threshold. The threshold typically is a predefined function of the standard deviation of the residual error R, which is given by:

$$R ( m , n ) = E ( {P}_{k} , A \cdot {\tilde{P}}_{k - 1} ) \vert \begin{matrix}{P}_{k} ∈ {B}_{k} ( m , n ) \\ {P}_{k - 1} ∈ {B}_{k - 1} ( m + {v}_{x} , n + {v}_{y} )\end{matrix} \qquad ( 9 )$$

where Pₖ, \tilde{P}ₖ₋₁ are the blocks associated by the motion vector (vₓ, v_{y}). Even with a fixed threshold, new outliers may be identified in each of the iterations and excluded.

Additional details regarding the determination of the camera motion parameter values 32 can be obtained from copending U.S. patent application Ser. No. 10/972,003, which was filed Oct. 25, 2004 by Tong Zhang et al., is entitled “Video Content Understanding Through Real Time Video Motion Analysis,” and is incorporated herein by reference.

### C. Exemplary Embodiments of the Output Video Generation Module

1. Overview

As explained above, the output video generation module 20 selects a set of shots of consecutive ones of the video frames 24 based on the frame characterizing parameter values 30 that are received from the frame characterization module 16 and the camera motion parameter values 32 that are received from the motion estimation module. The output video generation module 20 generates the output video 14 from the selected shots and optionally the audio data 26 or other audio content.

2. Generating Frame Quality Scores

The output video generation module 20 calculates a frame score for each frame based on the frame characterizing parameter values 30 that are received from the frame characterization module 16.

In some embodiments, the output video generation module 20 computes the frame scores based on the image quality scores 60 and face scores that depend on the appearance of detectable faces in the frames. In some implementations, the output video generation module 20 confirms the detection of faces within each given frame based on an averaging of the number of faces detected by the face detection module 52 in a sliding window that contains the given frame and a specified number of frames neighboring the given frame (e.g., W frames before and W frames after the given frame, where W has an integer value).

In some implementations, the value of the face score for a given video frame depends on the size of the facial bounding box that is received from the face detection module 52 and the facial region quality score 62 that is received from the image quality scoring module 54. The output video generation module classifies the detected facial area as a close-up face if the facial area is at least 10% of the total frame area, as a medium sized face if the facial area is at least 3% of total frame area, and a small face if the facial area is in the range of 1-3% of the total frame area. In one exemplary embodiment, the face size component of the face score is 45% of the image quality score of the corresponding frame for a close-up face, 30% for a medium sized face, and 15% for a small face.

In some embodiments, the output video generation module 20 calculates a respective frame score Sₙ for each frame n in accordance with equation (10):

Sₙ=Qₙ+FSₙ (10)

where Qₙ is the image quality score of frame n and FSₙ is the face score for frame n, which is given by:

$${FS}_{n} = \frac{\sqrt{{Area}_{face}}}{c} + \frac{{Q}_{face , n}}{d} \qquad ( 11 )$$

where Area_{face} is the area of the facial bounding box, Q_{face,n} is the facial region quality score 62 for frame n, and c and d are parameters that can be adjusted to change the contribution of detected faces to the frame scores.

In some embodiments, the output video generation module 20 assigns to each given frame a weighted frame score Sᵤₙ that corresponds to a weighted average of the frame scores Sₙ for frames in a sliding window that contains the given frame and a specified number of frames neighboring the given frame (e.g., V frames before and V frames after the given frame, where V has an integer value). The weighted frame score Sᵤₙ is given by equation (12):

$${S}_{wn} = [ {S}_{n} + {\sum }_{i = 1}^{m} ( ( {S}_{n + i} + {S}_{n - i} ) \times \frac{10 - i}{10} ) ] / ( 2 m + 1 ) \qquad ( 12 )$$

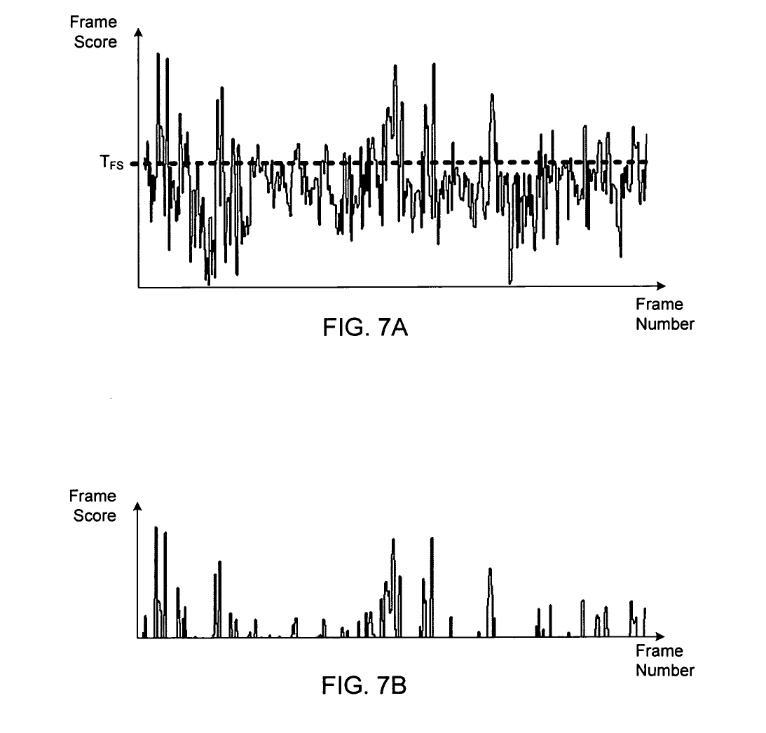

FIG. 7A shows an exemplary graph of the weighted frame scores that were determined for an exemplary set of input video frames 24 in accordance with equation (12) and plotted as a function of frame number.

3. Selecting Shots

As explained above, the output video generation module 20 identifies segments of consecutive ones of the video frames 24 based at least in part on a thresholding of the frame scores (see FIG. 2, block 44). In general, the threshold may be a threshold that is determined empirically or it may be a threshold that is determined based on characteristics of the video frames (e.g., the computed frame scores) or preferred characteristics of the output video 14 (e.g., the length of the output video).

In some embodiments, the frame score threshold (T_{FS}) is given by equation (13):

T_{FS}=T_{FS,AVE}+θ·(S_{wn,MAX}−S_{wn,MIN}) (13)

where T_{FS,AVE} is the average of the weighted frame scores for the video frames 24, S_{wn,MAX} is the maximum weighted frame score, S_{wn,MIN} is the minimum weighted frame score, and θ is a parameter that has a values in the range of 0 to 1. The value of the parameter θ determines the proportion of the frame scores that meet the threshold and therefore is correlated with the length of the output video 14.

In FIG. 7A an exemplary frame score threshold (T_{FS}) is superimposed on the exemplary graph of frame scores that were determined for an exemplary set of input video frames 24 in accordance with equation (12). FIG. 7B shows the frame scores of the video frames in the graph shown in FIG. 7A that exceed the frame score threshold T_{FS}.

Based on the frame score threshold, the output video generation module 20 segments the video frames 24 into an accepted class of video frames that are candidates for inclusion into the output video 14 and a rejected class of video frames that are not candidates for inclusion into the output video 14. In some embodiments, the output video generation module 20 labels with a “1” each of the video frames 24 that has a weighted frame score that meets the frame score threshold T_{FS} and labels with a “0” the remaining ones of the video frames 24. The groups of consecutive video frames that are labeled with a “1” correspond to the identified segments from which the output video generation module 20 selects the shots that will be used to generate the output video 14.

In addition to excluding from the accepted class video frames that fail to meet the frame score threshold, some embodiments of the output video generation module 20 exclude one or more of the following types of video frames from the accepted class:
ones of the video frames having respective focus characteristics that fail to meet a specified image focus predicate (e.g., at least 10% of the frame must be in focus to be included in the accepted class);
ones of the video frames having respective exposure characteristics that fail to meet a specified image exposure predicate (e.g., at least 10% of the frame must have acceptable exposure levels to be included in the accepted class);
ones of the video frames having respective color saturation characteristics that fail to meet a specified image saturation predicate (e.g., the frame must have at least medium saturation and facial areas must be in a specified “normal” face saturation range to be included in the accepted class);
ones of the video frames having respective contrast characteristics that fail to meet a specified image contrast predicate (e.g., the frame must have at least medium contrast to be included in the accepted class); and
ones of the video frames having detected faces with compositional characteristics that fail to meet a specified headroom predicate (e.g., when a face is detected in the foreground or mid-ground of a shot, the portion of the face between the forehead and the chin must be completely within the frame to be included in the accepted class).

In some implementations, the output video generation module 20 reclassifies ones of the video frames from the accepted class into the rejected class and vice versus depending on factors other than the assigned image quality scores, such as continuity or consistency considerations, shot length requirements, and other filmmaking principles. For example, in some embodiments, the output video generation module 20 applies a morphological filter (e.g., a one-dimensional closing filter) to incorporate within respective ones of the identified segments ones of the video frames neighboring the video frames labeled with a “1” and having respective image quality scores insufficient to satisfy the image quality threshold. The morphological filter closes isolated gaps in the frame score level across the identified segments and thereby prevents the loss of possibly desirable video content that otherwise might occur as a result of aberrant video frames. For example, if there are twenty video frames with respective frame scores over 150, followed by one video frame with a frame score of 10, followed by ten video frames with respective frame scores over 150, the morphological filter reclassifies the aberrant video frame with the low frame score to produce a segment with thirty-one consecutive video frames in the accepted class.

FIG. 8 shows a devised set of segments of consecutive video frames that are identified based at least in part on the thresholding of the image quality scores shown in FIGS. 7A and 7B.

As explained above, the output video generation module 20 selects from the identified segments shots of consecutive ones of the video frames 24 having motion parameter values meeting a motion quality predicate (see FIG. 2, block 46). The motion quality predicate defines or specifies the accepted class of video frames that are candidates for inclusion into the output video 14 in terms of the camera motion parameters 32 that are received from the motion estimation module 18. In one exemplary embodiment, the motion quality predicate M_{accepted} for the accepted motion class is given by:

M_{accepted}={pan rate≦Ωₚ and zoom rate≦Ω_{z}} (14)

where Ωₚ is an empirically determined threshold for the pan rate camera motion parameter value and Ω_{z} is an empirically determined threshold for the zoom rate camera motion parameter value. In one exemplary embodiment, Ωₚ=1 and Ω_{z}=1.

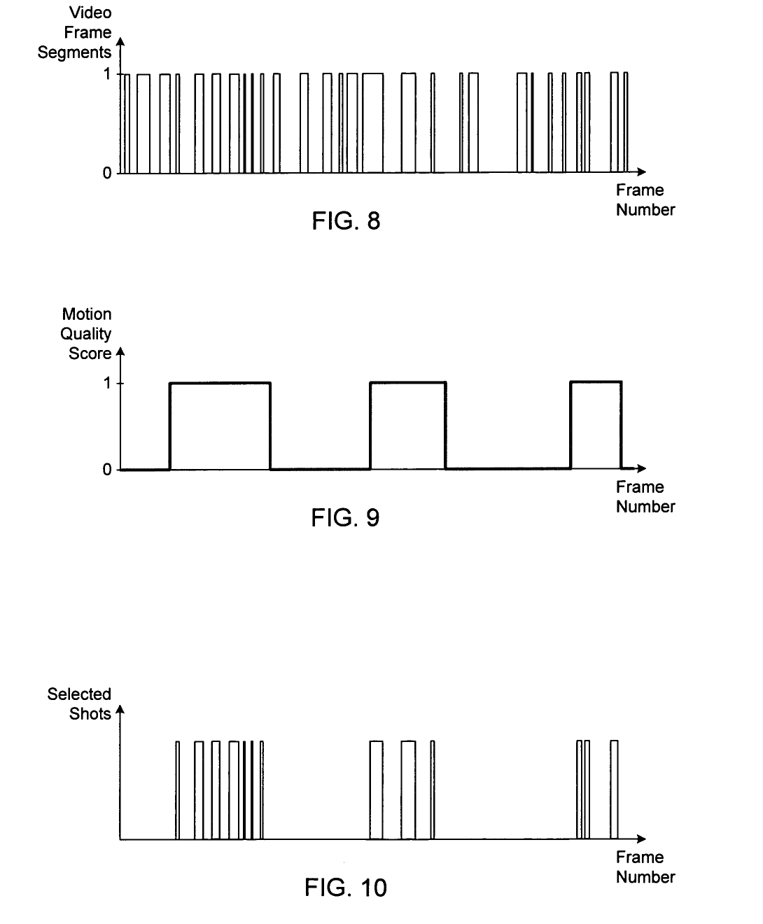

In some implementations, the output video generation module 20 labels each of the video frames 24 that meets the motion class predicate with a “1” and labels the remaining ones of the video frames 24 with a “0”. FIG. 9 shows a devised graph of motion quality scores indicating whether or not the motion quality parameters of the corresponding video frame meet a motion quality predicate.

The output video generation module 20 selects the ones of the identified video frame segments shown in FIG. 8 that contain video frames with motion parameter values that meet the motion quality predicate as the shots from which the output video 14 will be generated. FIG. 10 is a devised graph of shots of consecutive video frames selected from the identified segments shown in FIG. 8 and meeting the motion quality predicate as shown in FIG. 9.

In some embodiments, the output video generation module 20 also selects the shots from the identified segments shown in FIG. 8 based on user-specified preferences and filmmaking rules.

For example, in some implementations, the output video generation module 20 divides the input video data 12 temporally into a series of consecutive clusters of the video frames 24. In some embodiments, the output video generation module 20 clusters the video frames 24 based on timestamp differences between successive video frames. For example, in one exemplary embodiment a new cluster is started each time the timestamp difference exceeds one minute. For input video data that does not contain any timestamp breaks, the output video generation module 20 may segment the video frames 24 into a specified number (e.g., five) of equal-length segments. The output video generation module 20 then ensures that each of the clusters is represented at least one by the set of selected shots unless the cluster has nothing acceptable in terms of focus, motion and image quality. When one or more of the clusters is not represented by the initial round of shot selection, the output video generation module may re-apply the shot selection process for each of the unrepresented clusters with one or more of the thresholds lowered from their initial values.

In some implementations, the output video generation module 20 may determine the in-points and out-points for ones of the identified segments based on rules specifying one or more of the following: a maximum length of the output video 14; maximum shot lengths as a function of shot type; and in-points and out-point locations in relation to detected faces and object motion. In some of these implementations, the output video generation module 20 selects the shots from the identified segments in accordance with one or more of the following filmmaking rules:
No shot will be less than 20 frames long or greater than 2 minutes. At least 50% of the selected shots must be 10 seconds or less, and it is acceptable if all the shots are less than 10 seconds.
If a segment longer than 3 seconds has a consistent, unchanging image with no detectable object or camera motion, select a 2 second segment than begins 1 second after the start of the segment.
Close-up shots will last no longer than 30 seconds.
Wide Shots and Landscape Shots will last no longer than 2 minutes.
For the most significant (largest) person in a video frame, insert an in-point on the first frame that person's face enters the “face zone” and an out-point on the first frame after his or her face leaves the face zone. In some implementations, the face zone is the zone defined by vertical and horizontal lines located one third of the distance from the edges of the video frame.
When a face is in the foreground and mid-ground of a shot, the portion of the face between the forehead and the chin should be completely within the frame.
All shots without any faces detected for more than 5 seconds and containing some portions of sky will be considered landscape shots if at least 30% of the frame is in-focus, is well-exposed, and there is medium-to-high image contrast and color saturation.

In some embodiments, the output video generation module 20 ensures that an out-point is created in a given one of the selected shots containing an image of an object from a first perspective in association with a designated motion type only when a successive one of the selected shots contains an image of the object from a second perspective different from the first perspective in association with the designated motion type. Thus, an out-point may be made in the middle of an object (person) motion (examples: someone standing up, someone turning, someone jumping) only if the next shot in the sequence is the same object, doing the same motion from a different camera angle. In these embodiments, the output video generation module 20 may determine the motion type of the objects contained in the video frames 24 in accordance with the object motion detection and tracking process described in copending U.S. patent application Ser. No. 10/972,003, which was filed Oct. 25, 2004 by Tong Zhang et al., is entitled “Video Content Understanding Through Real Time Video Motion Analysis.” In accordance with this approach, the output video generation module 20 determines that objects have the same motion type when their associated motion parameters are quantized into the same quantization level or class.

4. Generating the Output Video

As explained above, the output video generation module 20 generates the output video 14 from the selected shots (see FIG. 2, block 48). The selected shots typically are arranged in chronological order with one or more transitions (e.g., fade out, fade in, dissolves) that connect adjacent ones of the selected shots in the output video 14. The output video generation module 20 may incorporate an audio track into the output video 14. The audio track may contain selections from one or more audio sources, including the audio data 26 and music and other audio content selected from an audio repository 50 (see FIG. 1).

In some implementations, the output video generation module 20 generates the output video 14 from the selected shots in accordance with one or more of the is following filmmaking rules:
The total duration of the output video 14 is scalable. The user could generate multiple summaries of the input video data 12 that have lengths between 1 and 99% of the total footage. In some embodiments, the output video generation module is configured to generate the output video 14 with a length that is approximately 5% of the length of the input video data 12.
In some embodiments, the output video generation module 20 inserts the shot transitions in accordance with the following rules: insert dissolves between shots at different locations; insert straight cuts between shots in the same location; insert a fade from black at the beginning of each sequence; and insert a fade out to black at the end of the sequence.

In some implementations, the output video generation module inserts cuts in accordance with the rhythm of an accompanying music track.

### III. CONCLUSION

The embodiments that are described in detail herein are capable of automatically producing high quality edited video content from input video data. At least some of these embodiments process the input video data in accordance with filmmaking principles to automatically produce an output video that contains a high quality video summary of the input video data.

Other embodiments are within the scope of the claims.

What is claimed is:

1. A method of processing input video data containing a sequence of video frames, comprising:
determining for each of the video frames respective frame characterizing parameter values and respective camera motion parameter values;
computing for each of the video frames a respective frame score based on the determined frame characterizing parameter values;
identifying segments of consecutive ones of the video frames based at least in part on a thresholding of the frame scores;
selecting from the identified segments shots of consecutive ones of the video frames having motion parameter values meeting a motion quality predicate; and
generating an output video from the selected shots.

2. The method of claim 1, wherein the determining comprises determining for each of the video frames respective values for one or more of the following frame characterizing parameters: sharpness, contrast, saturation, and exposure.

3. The method of claim 1, wherein the computing comprises computing for each given one of the video frames a respective frame score based on a weighted average of the frame characterizing parameter values determined for ones of the video frames within a specified number of frames of the given video frame.

4. The method of claim 1, further comprising detecting faces in the video frames and ascertaining respective facial parameter values for faces detected in respective ones of the video frames, wherein the computing comprises computing a respective frame score for each of the video frames containing a detected face based at least in part on the respective facial parameter values.

5. The method of claim 4, wherein the ascertaining comprises determining sizes of facial regions of the video frames containing detected faces and determining measures of image quality of the facial regions, and the computing comprises incorporating into the respective frame scores the determined sizes and image quality measures determined for the facial regions.

6. The method of claim 1, wherein the identifying comprises ascertaining ones of the video frames having respective frame scores satisfying a frame score threshold.

7. The method of claim 6, wherein the ascertaining comprises calculating the frame score threshold based on the computed frame scores.

8. The method of claim 7, wherein the calculating comprises calculating the frame score threshold based on a parameter correlated with the length of the output video.

9. The method of claim 6, wherein the identifying comprises applying a morphological filter to incorporate within respective ones of the identified segments ones of the video frames neighboring the ascertained video frames and having respective frame scores insufficient to satisfy the frame score threshold.

10. The method of claim 1, wherein the identifying comprises rejecting ones of the identified segments containing less than a minimum number of consecutive ones of the video frames.

11. The method of claim 1, wherein the identifying comprises excluding from the identified segments: ones of the video frames having respective focus characteristics that fail to meet a specified image focus predicate; ones of the video frames having respective exposure characteristics that fail to meet a specified image exposure predicate; ones of the video frames having respective color saturation characteristics that fail to meet a specified image saturation predicate; ones of the video frames having respective contrast characteristics that fail to meet a specified image contrast predicate.

12. The method of claim 1, further comprising detecting faces in the video frames, wherein the identifying comprises excluding from the identified segments ones of the video frames having detected faces with compositional characteristics that fail to meet a specified headroom predicate.

13. The method of claim 1, wherein the selecting comprises selecting from the identified segments shots of consecutive ones of the video frames having zoom rate parameter values and pan rate parameter values satisfying the motion quality predicate.

14. The method of claim 1, wherein the selecting comprises temporally dividing the input video data into a series of consecutive clusters of the video frames and selecting at least one shot from each of the clusters.

15. The method of claim 1, wherein the selecting comprises ensuring that the selected shots have respective shots lengths between a minimum shot length and a maximum shot length.

16. The method of claim 15, wherein the selecting comprises ensuring that a specified proportion of the selected shots having respective lengths below a shot length threshold between the minimum shot length and the maximum shot length.

17. The method of claim 1, further comprising identifying close-up shots, wide shots, and landscape shots, wherein the identifying comprises ensuring that ones of the selected shots that are identified as close-up shots have respective lengths below a close-up shot length threshold, ones of the selected shots that are identified as wide shots have respective lengths below a wide shot length threshold, and ones of the selected shots that are identified as landscape shots have respective lengths below a landscape shot length threshold.

18. The method of claim 1, further comprising detecting faces in the video frames, wherein the generating comprises creating an in-point when a detected face first moves into a designated face zone of ones of the video frames of the selected shots.

19. The method of claim 1, further comprising detecting object motion in the video frames, wherein the generating comprises ensuring that an out-point is created in a given one of the selected shots containing an image of an object from a first perspective in association with a designated motion type only when a successive one of the selected shots contains an image of the object from a second perspective different from the first perspective in association with the designated motion type.

20. A system for processing input video data containing a sequence of video frames, comprising:
a frame characterization module operable to determine respective frame characterizing parameter values for each of the video frames;
a motion estimation module operable to determine respective camera motion parameter values for each of the video frames; and
an output video generation module operable to
compute for each of the video frames a respective frame score based on the determined frame characterizing parameter values,
identify segments of consecutive ones of the video frames based at least in part on a thresholding of the frame scores,
select from the identified segments shots of consecutive ones of the video frames having motion parameter values meeting a motion quality predicate, and
generate an output video from the selected shots.
